(19) United States
(12) Patent Application Publication
(10) Pub. No.: US 2004/0262113 A1
(43) Pub. Date: Dec. 30, 2004

(54) Flexible pressing force transmission plate and method of manufacture

(75) Inventors: Thomas Rudolf, Schweinfurt (DE); Horst Friedrich, Happertshausen (DE); Klaus Fischer, Hassfurt (DE); Jurgen Loiberbeck, Grafenrheinfeld (DE); Werner Selzam, Wipfeld (DE); Jan Wittholz, Schonungen (DE); Arnold Huisjes, Schweinfurt (DE)

Correspondence Address: COHEN, PONTANI, LIEBERMAN & PAVANE, 551 FIFTH AVENUE, SUITE 1210, NEW YORK, NY, 10176, US

(73) Assignee: Sachs Race Engineering GmbH

(21) Appl. No.: 10/873,773

(22) Filed: Jun. 22, 2004

(30) Foreign Application Priority Data
Jun. 25, 2003 (DE) 103 28 426.5

(51) Int. Cl. F16D 13/50

(52) U.S. Cl. 192/70.27

(57) ABSTRACT

A pressing force transmission plate (126) for a friction clutch comprises an annular plate body (150) and at least one impingement area (152) for the introduction of a force exerted by an energy accumulator (130), preferably a diaphragm spring, wherein the plate body (150) and impingement area (152) are flexibly connected by a connection area (154), and wherein the plate body (150) and impingement area (152) form a leg spring arrangement.

### BACKGROUND OF THE INVENTION

### CROSS REFERENCES TO RELATED APPLICATIONS

The application claims priority under 35 U.S.C. §119 to German application DE 103 28 426.5 filed Jun. 25, 2003.

1. Field of the Invention

The present invention is directed to a pressing force transmission plate for a friction clutch, comprising an annular plate body and at least one impingement area for the introduction of a force provided by an energy accumulator, preferably a diaphragm spring.

2. Description of the Related Art

In friction clutches, the driving force provided by an energy accumulator designed for example as a diaphragm spring, is transmitted by an annular pressing plate to the friction members which have a frictional interaction with one another or which can be brought into frictional interaction with one another. Particularly in friction clutches used in racing, high loads occur on the friction members which, for this reason, are constructed as friction plates, for example. In these clutches, it is not possible for the lining spring system or lining suspension provided in conventional clutch disks to be provided in the area of the different friction members. However, it is precisely lining suspensions of this type which enable a more or less gradually occurring engagement state when engaging the clutch and which prevent a sudden, spontaneous rise in the clutch torque so that a comparatively high degree of comfort can be achieved in standard vehicle engineering.

Also in racing, there is a demand for this gradually occurring closing of the clutch, above all because the clutch torque transmitted by the clutch can then be adjusted more precisely. In the past, various concepts have been developed in order that a flexibility corresponding to the function of the lining suspension in conventional clutches can also be provided in the area of clutches of the type mentioned above.

It is known that flexible spring elements can be arranged in friction clutches between the pressing plate and a diaphragm spring acting upon the pressing plate. As taught in U.S. Pat. No. 3,323,624, for example, spring elements of this type can be constructed, for example, as helical pressure springs, correspondingly curved or bent leaf springs or as wave-shaped intermediate plates or intermediate rings. Further examples of spring elements and damping elements of this type are known from U.S. Pat. No. 4,095,683, U.S. Pat. No. 4,635,779 and EP 0 271 382 A1. In all of these arrangements, a determined pressing force applied by means of the diaphragm spring causes the curved or wavy spring elements arranged in the intermediate space between the pressing plate and diaphragm spring to be elastically deformed until the diaphragm spring contacts a stop of the pressing plate after a predetermined pressing force has been reached.

It has been suggested especially frequently to arrange a disk spring or helical spring between the pressing plate and a diaphragm spring acting upon the latter, see, e.g., EP 0 797 016 A2, U.S. Pat. No. 5,022,508 or U.S. Pat. No. 5,385,224. In order to act upon the pressing plate in these arrangements, the diaphragm spring initially primarily causes an increase in the disk spring tension and, by means of this, a corresponding pressing force against the pressing plate. When a predetermined pressing force has been reached, the disk spring finally contacts a stop that is correspondingly constructed at the pressing plate, so that after this point the pressing force of the diaphragm spring is transmitted directly to the pressing plate. The stop can be formed by a second contact point of the disk spring at the pressing plate (U.S. Pat. No. 5,022,508) or can be achieved through contact of substantially the entire surface of the disk spring at a conical (EP 0 797 016 A2) or curved (U.S. Pat. No. 5,385,224) surface of the pressing plate.

A disadvantage in all of the arrangements mentioned above consists in that an additional elastically acting structural component part is required. This leads, above all, to an increased expenditure in assembly and disassembly since care must be taken that the spring element which is loosely provided between the diaphragm spring and pressing plate is correctly installed.

As an alternative to the arrangement of a disk spring between the pressing plate and the diaphragm spring, DE 24 37 623 A1 also proposes that a substantially rectangular leaf spring be fastened, by means of a bolt or rivet, to the pressing plate on its side remote of the friction linings in an area projecting axially across from the pressing plate side. At its end located opposite from the bolt, this leaf spring is angled so as to form an impact area or impingement area for the diaphragm spring. Accordingly, the leaf spring is initially elastically deformed by the impingement of the diaphragm spring until its end at the impingement area comes into contact with the pressing plate when a determined force is exerted and the diaphragm spring then impinges directly on the pressing plate. This arrangement is disadvantageous particularly in that the leaf spring is subjected to a strong bending load chiefly in the area of the projecting edge, which can lead to spring breakage after the clutch has been actuated a certain number of times.

### SUMMARY OF THE INVENTION

Therefore, the present invention may provide a pressing force transmission plate for a friction clutch and a friction clutch having a pressing force transmission plate of this type which has an arrangement by which it is possible to carry out coupling processes in which the clutch torque can be precisely proportioned and which is extremely resistant to wear under operation. Further, a method is provided by which a pressing force transmission plate of this type can be manufactured simply and economically.

According to a first aspect of the present invention, this is met by a pressing force transmission plate for a friction clutch comprising an annular plate body and at least one impingement area for the introduction of a force exerted by an energy accumulator, preferably a diaphragm spring. The plate body and impingement area are flexibly connected by a connection area, and the plate body and impingement area form a leg spring arrangement.

Due to the arrangement as leg spring or stirrup spring, large forces can be elastically transmitted with only a small space requirement for the spring legs and using comparatively little material. The pressing force transmission plate and impingement area form an individual structural component part so that assembly requires no more effort than in clutches without a flexible element between the diaphragm spring and pressing force transmission plate. The connection area between the impingement area and plate body is elastically deformed when acted upon and makes possible a precise proportioning of the transmittable pressing force corresponding to its elasticity force without strong bending loads. It can be arranged in a relatively flexible manner in the axial intermediate space formed between the energy accumulator and plate body and beyond this in radial direction. This offers a wide variety of possibilities for the flux of force between the energy accumulator and the plate body by generating an elastic spring force in the connection portion. Depending on the desired requirement, one or more impingement areas can be provided and connected by corresponding connection areas to the plate body while forming a leg spring arrangement and form, in their entirety, an impingement area arrangement.

The connection area can comprise, e.g., a molded spring which, by a corresponding change in its geometry, generates an elastic restoring force itself when a corresponding impingement force acts between the spring legs. For example, the connection area can have an arc-shaped structure, wherein an increase in the curvature of the curve caused by the impingement force leads to generation of a restoring force.

In a simple and elegant possibility for manufacturing the pressing force transmission plate, the connection area is constructed in the manner of an elastically springing film hinge. Film hinges are known per se from plastics technology as tape hinges which have no mechanical parts. They comprise a flexible, thin-walled articulated groove between two parts to be connected. However, it has been shown that when a structure such as this is formed between two metal parts to be joined a corresponding connection can be formed which is not only durable and resistant to wear but also possesses sufficient elasticity. Further, the manufacture of a pressing plate of this kind requires only minor expenditure because a corresponding groove-like or slot-like structure can be produced already during production of a plate body blank (e.g., by casting, sintering or stamping a sheet metal part) in the connection area between the plate body and what is to be the impingement area. Alternatively, this can also be produced in a subsequent step without excessive extra expenditure, e.g., by pressing, milling or turning. The pressing force transmission plate with the impingement area can then be realized in its final form, e.g., by bending the blank in the area of the groove.

A plurality of connection areas can be arranged so as to follow one another approximately along a circumferential direction of the plate body, wherein the plurality of impingement areas form an impingement area arrangement. A certain distance is then preferably provided between the individual connection areas, each of which is assigned its own impingement area. Accordingly, the energy accumulator can exert force in such a way that the flux of force travels relatively uniformly over the surface of the pressing force transmission plate. The extension of an individual connection area in circumferential direction can be relatively small, so that the above-mentioned manufacture by means of bending a radial projection along a circumferential direction is readily possible.

The elasticity of the leg spring arrangement can be generated practically entirely in the connection area. In this case, the impingement area is constructed as a rigid structural component part and comprises a spring leg of the stirrup spring or leg spring which, when acted upon by a force, is substantially not deformable, i.e., excluding a certain unavoidable elastic deformation of the spring leg, although this is negligible in comparison to the flexible connection portion. The other spring leg is formed by the plate body of the pressing force transmission plate. In this respect, it can be provided that the impingement area is arranged at a predetermined acute angle relative to the plate body when the pressing force transmission plate is not acted upon. Therefore, when an impingement force acts upon the impingement area, this angle decreases until an elasticity force corresponding to the pressing force is generated by deformation of the connection area. Generally, it is provided that the force exerted by the energy accumulator is introduced at the end of the spring leg remote of the connection area, this spring leg being formed by the impingement area.

Further, it can be provided that the impingement area has a coupling surface in whose area it is rigidly connected to the plate body after a predetermined impingement force corresponding to a predetermined engine torque transmission has been reached. When the clutch is engaged again, the torque transmitted by the engine generally increases continuously until, after the predetermined engine torque has been reached, a substantially non-slip operation of the clutch is desired in which the clutch input torque and the clutch output torque are equal. Accordingly, after this predetermined clutch torque, the most rigid possible coupling of the drivetrain over the clutch must be aimed for. This means, in particular, that while the impingement force exerted on the pressing force transmission plate must be at least as high as that required for non-slip transmission of the greatest clutch torque present at the clutch after the predetermined clutch torque has been reached, it is no longer necessary to maintain a direct variation of the impingement force depending on the clutch input torque to the precise degree required with a slipping clutch. Therefore, it is entirely sufficient when the impingement force is transmitted directly from the energy accumulator along the impingement area to the plate body which is rigidly connected to the latter, for example, in that the impingement area is pressed directly against the plate body. Above all, an arrangement of this kind provides the advantage that the elastically acting connection area is relaxed after the predetermined impingement force has been reached so that wear can be reduced in the spring arrangement and breakage can be prevented.

As a rule, the plate body has a force transmission surface on a first axial side with respect to a plate axis, this force transmission surface cooperating with the clutch disk or with a second intermediate plate to transmit force. At its second axial side located opposite from the first axial side, at least one counter-coupling surface can be provided and the coupling surface of the respective impingement area can be supported against the latter. It is particularly advantageous when the second axial side of the plate body is substantially planar at least in the neighborhood of the counter-coupling surface. In this way, the spring leg comprising the impingement area is prevented from being pressed against an edge of the plate body when the coupling surface of the impingement area makes contact after the predetermined impingement force has been reached. Further, the impingement area can be pressed against the pressing plate body in the area of its coupling surface not only in a punctiform manner but in the area of the entire coupling surface. Consequently, there is no bending load on the corresponding spring leg. Ideally, the entire side of the impingement area facing the second axial side of the plate body is even constructed as a coupling surface which contacts the associated counter-coupling surface of the second axial side of the plate body when an impingement force is equal to or greater than the predetermined impingement force.

The connection area and impingement area can be constructed integral with the plate body. In particular, it is advantageous when the plate body, connection area and impingement area are formed from one piece. In accordance with the method already mentioned, a blank can then be formed initially for constructing the pressing force transmission plate body with projections formed radially at the latter. The corresponding impingement areas can then be formed by corresponding shaping, e.g., bending, of these projections.

Alternatively, the impingement area can also be fastened to the plate body, preferably welded or riveted to the plate body. In this case, the welding or riveting is to be carried out at a suitable location, generally inside the connection area to be constructed between the plate body and impingement area.

The connection area is preferably constructed in a radial end area of the plate body, particularly preferably in a radial outer end area of the plate body. In this case, the impingement area can then extend in radial direction of the plate body, wherein an acute angle is formed between the impingement area and plate body when the pressing force transmission plate is not acted upon, so that the pressing force transmission plate takes up only a little space in its entirety.

The invention is further directed to a friction clutch comprising a housing arrangement which is coupled or is to be coupled with a driving member so as to rotate jointly around an axis of rotation, an annular pressing force transmission plate which is coupled with the housing arrangement so as to be fixed with respect to rotation relative to it and so as to be displaceable relative to it in direction of the axis of rotation and which has a plate body which provides a pressing force transmission surface on a first axial side with respect to the plate axis, and an energy accumulator, preferably a diaphragm spring, which is supported at the housing arrangement and which can impinge on the pressing force transmission plate. The pressing force transmission plate comprises at least one impingement area for introducing a force provided by the energy accumulator, wherein the plate body and impingement area are elastically connected by a connection area, and wherein the plate body and impingement area form a leg spring arrangement.

Further, the invention provides a method for manufacturing a pressing force transmission plate for a friction clutch of the type mentioned above which comprises:

a) producing a metal blank, preferably a sheet metal blank, for the pressing force transmission plate by forming an annular plate body and at least one radially projecting projection formed at the latter; and

b) shaping the blank to form an impingement area which is designed for the introduction of an impingement force through an energy accumulator and which is connected to the plate body by a flexible connection area.

The pressing force transmission plate which is produced in this way is preferably fashioned from one piece. Alternatively, the blank can also be composed of a plurality of structural component parts connected integral with one another. To form the impingement area, the blank is machined in such a way, while retaining mass and material composition, preferably by corresponding bending, that its substantially planar shape is deformed preferably in the area of the radial projections. The projections are preferably arranged on the radial outer side, so that impingement areas extending from the outer side to the inner side can be formed by corresponding bending in radial direction. The metal blank is preferably stamped out of a flat sheet metal material, for example, a sheet steel of corresponding thickness. The shaping of the blank can be carried out, for example, in such a way that a respective projection is bent over the plate body along a radial end area of the plate body provided as connection area, if necessary with corresponding heat treatment, so that the corresponding impingement area is arranged at an acute angle to the plate body.

In addition, after producing the blank, the following step can be provided in the manufacturing process: formation of a structure at the blank for a connection area between a respective projection and the plate body. For this purpose, a slot-like or groove-like depression extending substantially in circumferential direction of the plate body can be formed, preferably by stamping, pressing, turning or milling, in a radial end area of the plate body provided as a connection area. In the subsequent shaping process, the corresponding projection is bent around this groove or slot to the extent that there results a corresponding impingement area which extends radially inward and which is arranged at an acute angle to the pressing plate body when the pressing force transmission plate is not acted upon. In this way, a flexible connection area joining a plate body and impingement area is formed in the manner of a film hinge. The invention will be described in detail in the following with reference to a preferred embodiment example.

Other features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a longitudinal section through a conventional multi-disk friction clutch.

FIG. 2 is a view in longitudinal section corresponding to FIG. 1 of a section from a multi-disk friction clutch with a pressing force transmission plate, according to the invention, on which no impingement force is exerted.

FIG. 3 shows the multi-disk friction clutch shown in FIG. 2 with maximum impingement on the pressing force transmission plate.

### DETAILED DESCRIPTION OF THE PRESENTLY PREFERRED EMBODIMENTS

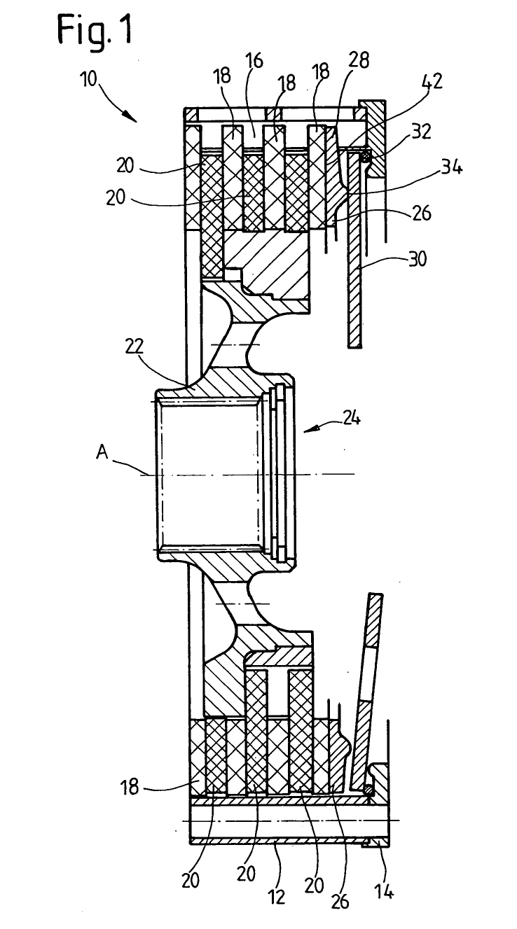

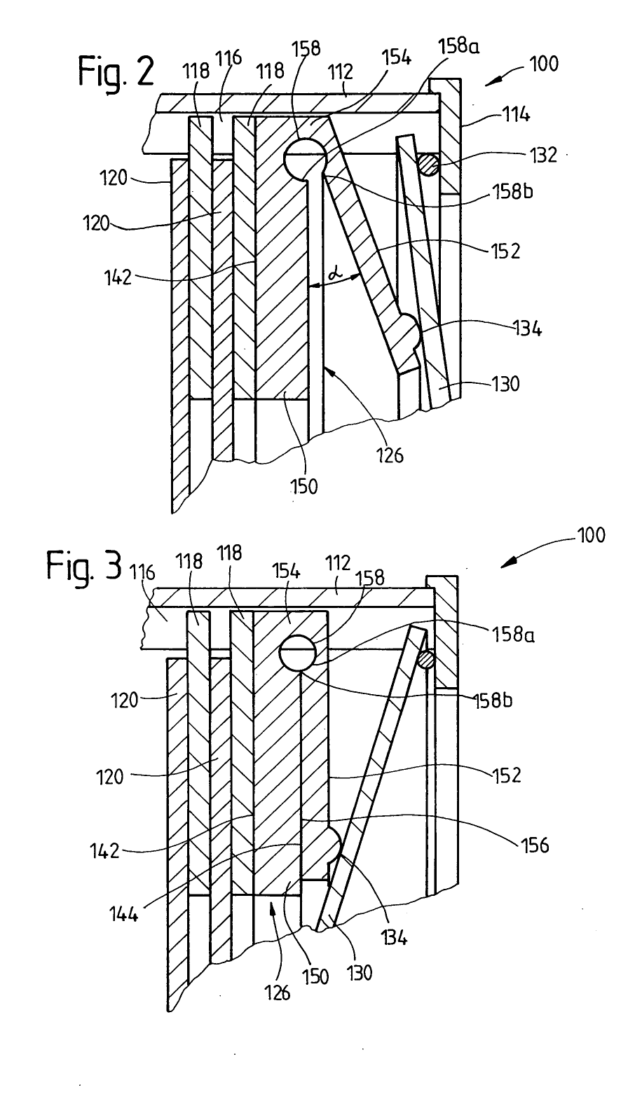

FIG. 1 shows a longitudinal section through a conventional multi-disk friction clutch. FIG. 2 is a view in longitudinal section corresponding to FIG. 1 of a section from a multi-disk friction clutch with a pressing force transmission plate, according to the invention, on which no impingement force is exerted.

A friction clutch 10 constructed as a multi-disk clutch is shown in FIG. 1. Friction clutches of this type are used, for example, in car racing. The friction clutch 10 comprises a housing arrangement 12 to which a housing cover 14 is fixedly connected at an axial end side (with reference to an axis of rotation A) by a plurality of threaded bolts or studs (not shown) arranged so as to be distributed along the circumference. At its inner side, the housing arrangement 12 has a plurality of coupling projections 16 which are distributed in circumferential direction and which extend in axial direction. Outer disks 18 engage with these coupling projections 16 so that the outer disks 18 are coupled with the housing arrangement 12 so as to be fixed with respect to rotation but displaceable in axial direction relative to them. Inner disks 20 are located between a plurality of outside disks 18. These inner disks 20 are coupled with a hub arrangement 22 of a clutch disk arrangement, designated generally by 24, so as to be fixed with respect to rotation relative to them but so as to be movable in axial direction to a certain extent. The hub arrangement 22 can then be coupled in a manner known per se to a transmission input shaft or the like so as to be fixed with respect to rotation relative to the latter.

Like the outer disks 18, an annular pressing force transmission plate 26 is also coupled with the housing arrangement 12 in the area of the projections 16 so as to be fixed with respect to rotation relative to it. For this purpose, the pressing force transmission plate 26 also has a plurality of coupling projections 28 distributed along the outer circumference. An energy accumulator 30 which is constructed, for example, as a diaphragm spring is supported in its radial outer area at the housing cover 14 by a wire ring 32 or the like and, farther radially inward, acts upon an impingement area 34 of the pressing force transmission plate 26, this impingement area 34 being constructed as a knife edge. A clutch release mechanism can act on the radial inner end area of the energy accumulator 30 so as to pull it in order to release the friction clutch 10. In the engaged state, the energy accumulator 30 acts upon the pressing force transmission plate 26 which transmits this impingement force to one of the outer disks 18 and therefore presses the outer disk 18 in frictional engagement with the inner disk 20. In so doing, a flywheel arrangement, not shown, to which the housing arrangement 12 and housing cover 14 can be fixedly connected can form an abutment. This flywheel arrangement can itself directly provide a friction surface cooperating with an inner disk 20, but can also serve merely as an axial support for one of the outer disks 18 so that in this case, as well as in the area of the pressing force transmission plate 26, there is no circumferential friction interaction with the following disk, namely an outer disk 18. The diaphragm spring 30 acts directly on the impingement area 34 of the pressing force transmission plate 26, so that the diaphragm spring and pressing force transmission plate are rigidly connected with one another.

FIG. 2 is a view in longitudinal section corresponding to FIG. 1 showing a section of a friction clutch 100, according to the invention, which is constructed as a multi-disk clutch and which has a pressing force transmission plate 126 with an impingement area 152 which is arranged elastically at the pressing force transmission plate 150. No impingement force is exerted on the pressing force transmission plate 126 shown in FIG. 2.

FIG. 3 shows the same multi-disk clutch as in FIG. 2. However, in contrast to the pressing force transmission plate 126 shown in FIG. 2 which is not acted upon, the pressing force transmission plate 126 in FIG. 3 is acted upon to the maximum extent. For the rest, structural component parts in FIGS. 2 and 3 that are identical or whose function is identical to those in FIG. 1 have the same reference numbers increased by 100. For a description of these structural component parts, reference is had to the description relating to FIG. 1.

The pressing force transmission plate 126 shown in FIGS. 2 and 3 has a substantially annular plate body 150 comprising at its axial annular surface, at left in FIGS. 2 and 3, a force transmission surface 142 which is in frictional engagement or can be brought into frictional engagement with the outer disk 118. Further, the pressing force transmission plate 126 comprises an impingement area 152 which is connected at the radial outer end of the pressing force transmission plate 126 to the plate body 150 and has at its free radial inner end a knife edge area 134 to be impinged on by the diaphragm spring 130. In the radial outer end area of the pressing force transmission plate 126, a flexible connection area 154 is formed between the plate body 150 and the impingement area 152. The cross section of the connection area 154 is smaller than that of the plate body 150 and of the impingement area 152. The plate body, connection area and impingement area are constructed in one piece from a metal blank by appropriate shaping. The connection area is constructed in the manner of a film hinge.

In the pressing force transmission plate according to the invention, the plate body 150 and impingement area 152 have two legs of a leg spring arrangement or stirrup spring arrangement which is formed by the plate body 150, the connection area 154 and the impingement area 152. It can be seen from FIG. 2 that when the pressing force transmission plate 126 is not acted upon the impingement area 152 is arranged at an acute angle α to the plate body 150. A cutout 158 which is shaped approximately like an arc segment is formed in the connection area 154. The cross section of the pressing force transmission plate 126 is reduced in the area of the cutout 158 compared to the plate body 150 and impingement area 152. While the plate body 150 and impingement area 152 form a substantially rigid spring leg, i.e., they are deformed only negligibly compared to the connection portion when acted upon by an impingement force through the diaphragm spring 130, the connection area 154 has a certain elasticity. This elasticity stems from the fact that the angle α between the impingement area 152 and plate body 150 is initially reduced under the influence of the impingement force through the diaphragm spring 130 and the two end points 158a and 158b of the arc-shaped cutout 158 move toward one another in the connection area 154 so that the curvature of the arc formed by the cutout is increased. This simultaneously causes an elastic restoring force to be generated which acts so as to restore the original angle α between the impingement area 152 and the plate body 150. The greater the impingement force and, therefore, the smaller the angle between the impingement area 152 and plate body 150, the greater this restoring force and, therefore, also the greater the total pressing force which can be transmitted via the pressing force transmission plate 126.

Finally, when a predetermined impingement force is achieved, the end position shown in FIG. 3 is reached. The axial side surface 156 of the impingement area 152 facing the plate body 150 now fully contacts the axial annular surface 144 of the plate body located opposite the force transmission surface 142. Accordingly, a flux of force from the impingement area 152 to the plate body 150 is accordingly no longer carried out via the flexible connection area 154, but rather directly over the surfaces 156, 144 of the impingement area 152 and plate body 150 contacting one another. Thus, when the predetermined impingement force has been reached, the connection area 154 is fully relaxed. This prevents damage to or breakage of the flexible connection between the plate body 150 and impingement area 152 even with very high impingement forces such as are required for transmitting high clutch torques. Further, the relatively large-area contact between the coupling surface 156 of the impingement area 152 and the counter-coupling surface 144 of the plate body 150 also prevents damage to or severe wear of the pressing force transmission plate 126 through high and/or frequently occurring impingement forces.

The pressing force transmission plate 126 that is provided according to the invention can be manufactured with only a slight additional manufacturing cost compared to a conventional pressing force transmission plate. It occupies hardly any more space or weighs hardly more than a conventional pressing force transmission plate, but provides an appreciably more accurately adjustable transmittable clutch torque, above all during engagement and release of the clutch. The flexible connection of the pressing plate body and impingement area results in an integral structural component part which can be assembled in a simple manner and—above all, because of the reduced bending load and effective relaxing of the flexible connection area when high clutch torques are to be transmitted—is extremely resistant to wear at the same time.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A pressing force transmission plate (126) for a friction clutch, comprising:
an annular plate body (150);
an energy accumulator (130);
at least one impingement area (152) of the annular plate body for the introduction of a force exerted by the energy accumulator (130); and
a connection area (154) wherein the annular plate body (150) and impingement area (152) are flexibly connected by the connection area (154), and wherein the annular plate body (150) and impingement area (152) together form a leg spring arrangement with the annular plate body (150) forming a first leg and with the impingement area (152) forming a second leg and the first and second legs are connected by connection area (152).

2. The pressing force transmission plate according to claim 1, wherein the connection area (154) comprises a molded spring portion (158).

3. The pressing force transmission plate according to claim 1, wherein the connection area (154) is constructed of an elastically springing film hinge.

4. The pressing force transmission plate according to claim 1, wherein a plurality of impingement areas (152) forms an impingement area arrangement, and wherein a plurality of connection areas (154) are arranged so as to follow one another approximately along a circumferential direction of the annular plate body (150).

5. The pressing force transmission plate according to claim 1, wherein the impingement area (152) comprises a spring leg which is not deformable under the influence of an impingement force, and another spring leg is formed by the annular plate body (150).

6. The pressing force transmission plate according to claim 1, wherein the impingement area (152) is arranged at a predetermined acute angle (a) relative to the annular plate body (150) when the pressing force transmission plate is not acted upon.

7. The pressing force transmission plate according to claim 1, wherein the impingement area (152) has a coupling surface (156) in whose area it is rigidly press connected to the annular plate body (150) after a predetermined impingement force corresponding to a predetermined engine torque transmission has been reached.

8. The pressing force transmission plate according to claim 7, wherein the annular plate body (150) has a force transmission surface (142) on a first axial side with respect to a plate axis and, at a second axial side located opposite from the first axial side, has at least one counter-coupling surface (144) for supporting the coupling surface (156) of the respective impingement area (152).

9. The pressing force transmission plate according to claim 8, wherein the second axial side of the annular plate body (150) is substantially planar at least proximate to the counter-coupling surface (144).

10. The pressing force transmission plate according to claim 9, wherein the entire side of the impingement area (152) facing the second axial side of the annular plate body (150) is constructed as a coupling surface (156) which contacts the associated counter-coupling surface (144) of the second axial side of the annular plate body (150) when an impingement force is equal to or greater than a predetermined impingement force.

11. The pressing force transmission plate according to claim 1, wherein the connection area (154) and impingement area (152) are constructed integrally with the annular plate body (150).

12. The pressing force transmission plate according to claim 11, wherein the annular plate body (150), connection area (154) and impingement area (152) are formed from one piece.

13. The pressing force transmission plate according to claim 11, wherein the impingement area (152) is fastened, welded, or riveted to the annular plate body (150).

14. The pressing force transmission plate according to claim 1, wherein the connection area (154) is formed in a radial end area of the annular plate body (150).

15. A friction clutch comprising:
a driving member;
a housing arrangement (12, 14) which is coupleable with the driving member so as to rotate jointly around an axis of rotation;
a pressing force transmission plate (126) which is annular and which is coupled with the housing arrangement (12, 14) and structured to be fixed with respect to rotation relative to the housing arrangement and structured to be displaceable relative to the housing arrangement (12, 14) in direction of the axis of rotation (A);
an annular plate body (150) having a pressing force transmission surface (142) on a first axial side with respect to a plate axis (A);
an energy accumulator (134) which is supported at the housing arrangement (12, 14) and which can act on the pressing force transmission plate (126);
wherein the pressing force transmission plate (126) comprises at least one impingement area (152) for introducing a force provided by the energy accumulator (134) and a connection area (154), wherein the annular plate body (150) and the impingement area (152) are elastically connected by the connection area (154); and
wherein the annular plate body (150) and impingement area (152) together form a leg spring arrangement with the annular plate body (150) forming a first leg and with the impingement area forming a second leg and wherein the legs are connected by connection area (152).

16. A method for manufacturing a pressing force transmission plate (126) for a friction clutch comprising:
a) producing a metal blank for a pressing force transmission plate (126) by forming an annular plate body (150) with at least one radially projecting projection formed on the annular plate body (150); and
b) shaping the blank and the at least one radially projecting projection to form an impingement area (152) for the introduction of an impingement force through an energy accumulator; and
c) shaping the blank to have a connection area (154) which forms an elastic connection area (154) between the annular plate body (150) and the impingement area (152).

17. A method according to claim 16, wherein in that the blank is stamped from a sheet metal material.

18. A method according to claim 16, wherein a respective projection is bent over the annular plate body (150) along a radial end area of the annular plate body provided as connection area (154), so that the corresponding impingement area (152) is arranged at an acute angle (a) to the annular plate body (150).

19. A method according to claim 16 further comprising:
forming a structure at the blank for a connection area (154) between a respective projection and the annular plate body (150).

20. A method according to claim 19, wherein a groove-like depression extending substantially in circumferential direction of the annular plate body (150) is formed by stamping, pressing, turning or milling, in a radial end area of the annular plate body (150) provided as connection area (154).
